(19) United States
(12) Patent Application Publication
(10) Pub. No.: US 2026/0298413 A1
(43) Pub. Date: Oct. 1, 2026

(54) SYSTEMS AND METHODS FOR EMPTYING STORAGE DEVICES

(71) Applicant: CNX Resources Corporation, Canonsburg, PA (US)

(72) Inventor: Kevin Robert Egeland, Pittsburgh, PA (US)

(21) Appl. No.: 19/090,054

(22) Filed: Mar. 25, 2025

(51) Int. Cl. F17C 7/02

(52) U.S. Cl. CPC F17C 7/02; F17C 2227/0309

(57) ABSTRACT

A system includes a storage device to receive and deliver a compressible fluid simultaneously. In addition, the system includes a distribution line to fluidly couple an outlet of the storage device to a demand to deliver a first portion of the compressible fluid exiting the storage device to the demand and a circulation line to fluidly couple the outlet of the storage device to an inlet of the storage device to deliver a second portion of the compressible fluid exiting the storage device to the inlet of the storage device. The system further includes a compressor in fluid communication with the circulation line to increase a pressure of the second portion of the compressible fluid and a circulation heater in thermal communication with the circulation line to increase a temperature of the second portion of the compressible fluid.

### TECHNICAL FIELD

The present disclosure relates to systems and methods for emptying compressible fluid storage devices, such as compressed natural gas (CNG) storage devices. Specifically, the disclosed systems and methods advantageously prevent undesirable temperatures within compressible fluid storage devices during emptying operations of the compressible fluid storage devices.

### BACKGROUND

A common process for the distribution of compressible fluids, such as compressed natural gas (CNG), may include dispensing a compressible fluid from a high-pressure source into a compressible fluid storage device, transporting the compressible fluid storage device to a destination, delivering the compressible fluid within the compressible fluid storage device to a low-pressure demand at the destination, and transporting the depleted compressible fluid storage device back to the high-pressure source to restart the process.

During a compressible fluid emptying operation (e.g., the step of delivering the compressible fluid within a compressible fluid storage device to a low-pressure demand), a compressible fluid storage device may experience a significant temperature decrease. Specifically, as fluid is delivered from the compressible fluid storage device, the pressure within the compressible fluid storage device decreases. Accordingly, the temperature of the fluid within the compressible fluid storage device decreases as the pressure within the compressible fluid storage device decreases.

The temperature change within compressible fluid storage devices may have various detrimental effects during a compressible fluid emptying operation. For example, temperature decreases within a compressible fluid storage device routinely delay a drawdown of the compressible fluid storage device to an acceptably low fluid density. When the temperature of the fluid in the compressible fluid storage device approaches a minimum operating temperature of the compressible fluid storage device (as defined by the compressible fluid storage device manufacturer, e.g. −40° F. to −70° F. for a CNG storage device) or a minimum operating temperature of the hoses used to temporarily connect the compressible fluid storage device to the low-pressure demand (e.g. approximately −40° F.), the emptying operation must be temporarily halted to allow the fluid within the compressible fluid storage device to be warmed up (e.g., by heat transfer with ambient air through the wall of the compressible fluid storage device). If an uninterrupted stream of fluid is required by a consumer, another compressible fluid storage device must be present at the destination to provide fluid once the compressible fluid storage device in question approaches its minimum operating temperature.

### SUMMARY

In a first embodiment, the present disclosure describes a system including a storage device to receive and deliver a compressible fluid simultaneously. In addition, the system includes a distribution line to fluidly couple an outlet of the storage device to a demand to deliver a first portion of the compressible fluid exiting the storage device to the demand and a circulation line to fluidly couple the outlet of the storage device to an inlet of the storage device to deliver a second portion of the compressible fluid exiting the storage device to the inlet of the storage device. The system further includes a compressor in fluid communication with the circulation line to increase a pressure of the second portion of the compressible fluid and a circulation heater in thermal communication with the circulation line to increase a temperature of the second portion of the compressible fluid.

In one aspect of the first embodiment, the system further includes a distribution heater in thermal communication with the distribution line to increase a temperature of the first portion of the compressible fluid.

In another aspect of the first embodiment, which may be combined with one or more previously recited aspects of the first embodiment, the system further includes a flow control valve in fluid communication with the distribution line to control a flow rate of the first portion of the compressible fluid.

In another aspect of the first embodiment, which may be combined with one or more previously recited aspects of the first embodiment, the system further includes one or more sensors to measure one or more characteristics of the compressible fluid within or exiting the storage device.

In another aspect of the first embodiment, which may be combined with one or more previously recited aspects of the first embodiment, the system further includes one or more stoppage valves to control a flow of the compressible fluid exiting the storage device. The one or more stoppage valves are operable to actuate based on the one or more characteristics of the compressible fluid within or exiting the storage device meeting a threshold.

In another aspect of the first embodiment, which may be combined with one or more previously recited aspects of the first embodiment, the one or more characteristics of the compressible fluid within or exiting the storage device include one or more of a temperature of the compressible fluid or a pressure of the compressible fluid.

In another aspect of the first embodiment, which may be combined with one or more previously recited aspects of the first embodiment, the storage device is a storage tank array including a plurality of storage tanks fluidly coupled in parallel between an inlet manifold and an outlet manifold. The inlet manifold is operable to deliver the second portion of the compressible fluid from the circulation line to an inlet of each storage tank of the plurality of storage tanks. The outlet manifold is operable to deliver a portion of the compressible fluid from an outlet of each storage tank of the plurality of storage tanks to the distribution line and the circulation line.

In another aspect of the first embodiment, which may be combined with one or more previously recited aspects of the first embodiment, the inlet of each storage tank is disposed at a first end of the storage tank and the outlet of each storage tank is disposed at a second end of the storage tank.

In another aspect of the first embodiment, which may be combined with one or more previously recited aspects of the first embodiment, the inlet and the outlet of each storage tank are disposed at a first end of the storage tank, and each storage tank includes a conduit extending, within an interior of the storage tank, from the inlet or the outlet towards a second end of the storage tank.

In a second embodiment, the present disclosure describes a method that includes delivering a first portion of a compressible fluid exiting a storage device to a demand, delivering a second portion of the compressible fluid exiting the storage device to an inlet of the storage device, increasing a pressure of the second portion of the compressible fluid, and increasing a temperature of the second portion of the compressible fluid.

In one aspect of the second embodiment, the method further includes increasing a temperature of the first portion of the compressible fluid.

In another aspect of the second embodiment, which may be combined with one or more previously recited aspects of the second embodiment, the method further includes controlling a flow rate of the first portion of the compressible fluid.

In another aspect of the second embodiment, which may be combined with one or more previously recited aspects of the second embodiment, the method further includes measuring one or more characteristics of the compressible fluid within or exiting the storage device.

In another aspect of the second embodiment, which may be combined with one or more previously recited aspects of the second embodiment, the method further includes controlling a flow of the compressible fluid exiting the storage device based at least in part on the one or more characteristics of the compressible fluid within or exiting the storage device meeting a threshold.

In another aspect of the second embodiment, which may be combined with one or more previously recited aspects of the second embodiment, the method further includes fluidly disconnecting the storage device from the demand and fluidly connecting an additional storage device to the demand.

In a third embodiment, the present disclosure describes an assembly including a demand and a plurality of systems. Each system includes a storage device to receive and deliver a compressible fluid simultaneously. In addition, each system includes a distribution line to fluidly couple an outlet of the storage device and the demand to deliver a first portion of the compressible fluid exiting the storage device to the demand and a circulation line to fluidly couple the outlet of the storage device and an inlet of the storage device to deliver a second portion of the compressible fluid exiting the storage device to the inlet of the storage device. Each system further includes a compressor in fluid communication with the circulation line to increase a pressure of the second portion of the compressible fluid and a circulation heater in thermal communication with the circulation line to increase a temperature of the second portion of the compressible fluid.

In one aspect of the third embodiment, each system includes a distribution heater in thermal communication with the distribution line to increase a temperature of the first portion of the compressible fluid.

In another aspect of the third embodiment, which may be combined with one or more previously recited aspects of the third embodiment, each system includes a flow control valve in fluid communication with the distribution line to control a flow rate of the first portion of the compressible fluid.

In another aspect of the third embodiment, which may be combined with one or more previously recited aspects of the third embodiment, each system includes one or more sensors to measure one or more characteristics of the compressible fluid within or exiting the storage device.

In another aspect of the third embodiment, which may be combined with one or more previously recited aspects of the third embodiment, each system includes one or more stoppage valves to control a flow of the compressible fluid exiting the storage device. The one or more stoppage valves are operable to actuate based on the one or more characteristics of the compressible fluid within or exiting the storage device meeting a threshold.

These and other features and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 is a schematic diagram illustrating a system according to one or more embodiments of the present disclosure.

FIG. 2 is a schematic diagram illustrating a storage device according to one or more embodiments of the present disclosure.

FIG. 3 is a schematic diagram illustrating a storage device according to one or more embodiments of the present disclosure.

FIG. 4 is a schematic diagram illustrating a storage device according to one or more embodiments of the present disclosure.

FIG. 5 is a flowchart of a method according to one or more embodiments of the present disclosure.

FIG. 6 is a graph depicting example pressures within storage devices during a first emptying operation and a second emptying operation according to one or more embodiments of the present disclosure.

FIG. 7 is a graph depicting example temperatures within storage devices during a first emptying operation and a second emptying operation according to one or more embodiments of the present disclosure.

FIG. 8 is a graph depicting example total heat duties of systems during a first emptying operation and a second emptying operation according to one or more embodiments of the present disclosure.

FIG. 9 is a graph depicting example operating conditions of a compressor during an emptying operation according to one or more embodiments of the present disclosure.

FIG. 10 is a schematic diagram illustrating an assembly according to one or more embodiments of the present disclosure.

### DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims.

In the following description, it is to be understood that such terms as “forward,” “rearward,” “left,” “right,” “above,” “below,” “upward,” “downward,” and the like are words of convenience and are not to be construed as limiting terms.

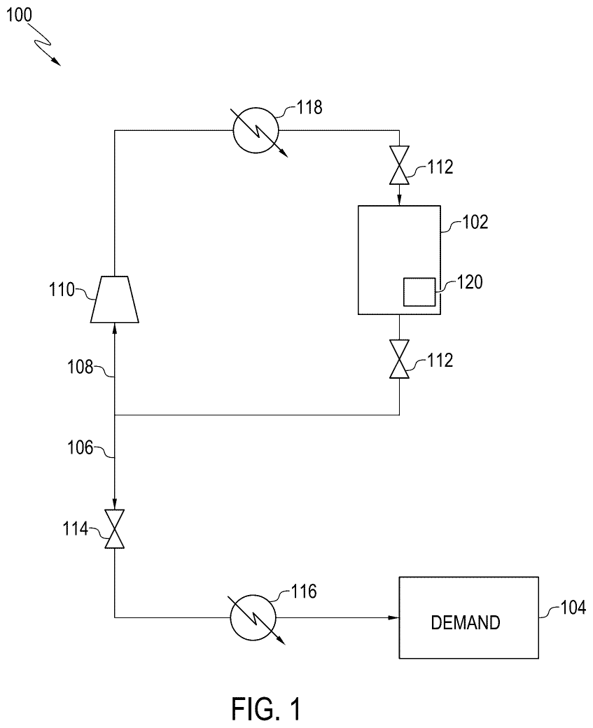

FIG. 1 depicts a schematic diagram of a system 100 according to one or more embodiments of the present disclosure. The system 100 includes a storage device 102 operable to deliver a compressible fluid to a demand 104. The storage device 102 may be a sealed rigid container(s), a stationary tank, a mobile trailer, or an equivalent device known to those of ordinary skill in the art. In one or more embodiments, the storage device 102 may be disposed upon and transported by a mobile unit. In one or more embodiments, the compressible fluid stored within the storage device 102 is a compressed natural gas, which the industry defines as CNG.

In one or more embodiments, the demand 104 may be embodied as a low-pressure distribution pipeline (e.g., a residential natural gas distribution pipeline), an engine operable to produce mechanical power (e.g., a gas turbine, reciprocating internal-combustion engine, etc.), an electrical generator, a chemical process (e.g., a methane reformer, methane pyrolyzer, Haber-Bosch process, etc.), or any other element or process known to those of ordinary skill in the art.

The system 100 further includes a plurality of flow lines. The plurality of flow lines may be formed as piping, hosing, or an equivalent form of conduit. In addition, the plurality of flow lines may be formed of polymer, metal, or an equivalent material known to those of ordinary skill in the art which is designed to withstand the temperatures and pressures associated with an emptying operation of compressible fluid storage devices. The plurality of flow lines includes a distribution line 106 and a circulation line 108.

The distribution line 106 is operable to fluidly couple an outlet of the storage device 102 and the demand 104 to deliver a first portion of the compressible fluid exiting the storage device 102 to the demand 104. In one or more embodiments, the flow of the first portion of the compressible fluid from the storage device 102 to the demand 104 is driven through the distribution line 106 by the pressure differential between the storage device 102 and the demand 104. As such, in one or more embodiments, external power need not be applied to the system 100 to transport the first portion of the compressible fluid through the distribution line 106. That is, in one or more embodiments, the first portion of the compressible fluid may flow through the distribution line 106 without the use of pumps, compressors, or any similar device that consumes power. Alternatively, in one or more embodiments, one or more devices (e.g., pumps, compressors, etc.) may be fluidly coupled to the distribution line 106 in order to aid in the delivery of the first portion of the compressible fluid to the demand 104. The energy consumed by such devices may be derived from the compressible fluid within the system 100 or from a source external to the system 100.

The circulation line 108 is operable to fluidly couple the outlet of the storage device 102 to an inlet of the storage device 102 to deliver a second portion of the compressible fluid exiting the storage device 102 to the inlet of the storage device 102. In one or more embodiments, the flow of the second portion of the compressible fluid from the outlet of the storage device 102 to the inlet of the storage device 102 is driven through the circulation line 108 by one or more compressors 110 fluidly coupled to the circulation line 108. Each compressor 110 is operable to increase and control a pressure of the second portion of the compressible fluid. That is, each compressor 110 is operable to receive compressible fluid at a first pressure and output the compressible fluid at a second, increased pressure. The one or more compressors 110 may be any combination of one or more appropriate compressors, including positive-displacement compressors (e.g., reciprocating compressors, rotary screw compressors, etc.), dynamic compressors (e.g., centrifugal compressors, axial compressors, etc.), and any combination thereof. The energy consumed by the one or more compressors 110 may be derived from the compressible fluid within the system 100 or from a source external to the system 100.

The system 100 further includes one or more stoppage valves 112 in fluid communication with the plurality of flow lines. Each stoppage valve 112 is operable to control a flow of the compressible fluid by actuation between a closed configuration and an open configuration. That is, when a stoppage valve 112 is in a closed configuration, the stoppage valve 112 prevents fluid from passing through the stoppage valve 112. Further, when a stoppage valve 112 is in an open configuration, the stoppage valve 112 permits fluid to pass through the stoppage valve 112. As such, one or more stoppage valves 112 may be fluidly coupled to the outlet of the storage device 102 and operable to control the flow of compressible fluid exiting the storage device 102, and one or more stoppage valves 112 may be fluidly coupled to the inlet of the storage device 102 and operable to control the flow of compressible fluid entering the storage device 102. Furthermore, one or more stoppage valves 112 may be operable to permit or prevent fluid communication between the demand 104 and the storage device 102.

In one or more embodiments, the system 100 includes one or more flow control valves 114 in fluid communication with the plurality of flow lines. Each flow control valve 114 is operable to control a flow rate of the compressible fluid passing through the flow control valve 114. Each flow control valve 114 of the one or more flow control valves 114 may have a same or different target flow rate.

Alternatively, in one or more embodiments, one or more stoppage valves 112 may be further operable to control the flow rate of fluid passing through the one or more stoppage valves 112. For instance, the one or more stoppage valves 112 may be positioned in one or more intermediate positions between an open configuration and a closed configuration in order to control the flow rate of the fluid passing through the one or more stoppage valves 112.

In one or more embodiments, the one or more stoppage valves 112 and the one or more flow control valves 114 may be any type of valve suitable for flow control and flow rate control, respectively, at pressures up to, for example, 5,000 psig. In one or more embodiments, the one or more stoppage valves 112 and the one or more flow control valves 114 may be selectively operated in a manual operation mode. That is, a stoppage valve 112 or a flow control valve 114 may be selectively and manually positioned by rotating a handle of the valve, pressing buttons on the valve, etc. In one or more embodiments, each stoppage valve 112 and each flow control valve 114 includes an electrical, hydraulic, or pneumatic actuator, such that the positioning of the one or more stoppage valves 112 and the one or more flow control valves 114 may be performed automatically in response to a signal received from a control circuit of the system 100. The actuators of the one or more stoppage valves 112 and the one or more flow control valves 114 may be fast-acting and operable to rapidly transition a valve between a closed configuration and an open configuration, as well as the one or more intermediate positions between the closed configuration and the open configuration.

The system 100 further includes a plurality of heaters in fluid communication with the plurality of flow lines. Each heater of the plurality of heaters is operable to control a temperature of the compressible fluid passing through the heater. Each heater may be a form of heat exchanger or another device suitable for controlling a temperature of a fluid stream. The energy consumed by each heater of the plurality of heaters may be derived from the compressible fluid within the system 100 or from a source external to the system 100.

In one or more embodiments, the plurality of heaters includes a distribution heater 116 in thermal communication with the distribution line 106 that is operable to increase and control a temperature of the first portion of the compressible fluid. In the non-limiting example of FIG. 1, the distribution heater 116 is disposed downstream of a flow control valve 114 along the distribution line 106. However, in one or more embodiments, the distribution heater 116 may be disposed upstream of a flow control valve 114.

In one or more embodiments, the plurality of heaters includes a circulation heater 118 in thermal communication with the circulation line 108 that is operable to increase and control a temperature of the second portion of the compressible fluid. In the non-limiting example of FIG. 1, the circulation heater 118 is disposed downstream of a compressor 110 along the circulation line 108. However, in one or more embodiments, the circulation heater 118 may be disposed upstream of a compressor 110. Further, in one or more embodiments, the circulation heater 118 may include a maximum output temperature, and the maximum output temperature may be a predetermined value below a maximum operating temperature of a storage device 102 (e.g., approximately 180° F.).

In one or more embodiments, one or more sensors 120 may be coupled to the storage device 102 that measure and monitor one or more characteristics of the compressible fluid within the storage device 102 (e.g., temperature, pressure, density, etc.). In one or more embodiments, one or more sensors 120 may be coupled to a flow line downstream of the outlet of the storage device 102 to measure and monitor one or more characteristics of the compressible fluid exiting the storage device 102. The one or more sensors 120 may be operable to determine whether the one or more characteristics are above or below predetermined thresholds. Accordingly, the one or more sensors 120 may trigger an audible or visual alert notifying an operator of the system 100 that one or more characteristics of the compressible fluid within or exiting the storage device 102 have met a predetermined threshold. For example, as compressible fluid is delivered to the demand 104, the pressure within the storage device 102 decreases, and thus, the one or more sensors 120 may trigger an audible or visual alert in response to a predetermined pressure within the storage device 102 being met.

In or more embodiments, the system 100 may further include a control circuit in electronic communication with the one or more sensors 120 and one or more additional components of the system 100 (e.g., the one or more stoppage valves 112, the one or more flow control valves 114, the one or more compressors 110, the plurality of heaters, etc.). In this way, the one or more sensors 120 may be operable to communicate one or more signals to the control circuit indicating that one or more thresholds of the one or more characteristics of the compressible fluid within or exiting the storage device 102 have been met. Alternatively, the one or more sensors 120 may continuously or regularly communicate information captured by the one or more sensors 120, and the control circuit may determine whether one or more characteristics of the compressible fluid within or exiting the storage device 102 are above or below predetermined thresholds. Accordingly, the control circuit may be operable to actuate or modulate one or more components of the system 100 in response to a predetermined threshold being met. For example, the control circuit may be operable to modulate a compressor 110, thereby altering a flow rate through the compressor 110, in response to one or more characteristics meeting a threshold.

The control circuit may include at least one processor programmed to execute instructions stored on computer-readable media. The control circuit may communicate with the one or more sensors 120 and one or more additional components of the system 100 (e.g., the one or more stoppage valves 112, the one or more flow control valves 114, the one or more compressors 110, the plurality of heaters, etc.) by any suitable wired or wireless communication protocols and interfaces such as 4-20 milliamp HART signal, Ethernet, fiber optics, coaxial, infrared, radio frequency (RF), a universal serial bus (USB), Wi-Fi®, cellular network, or the like. The control circuit may be in communication with a user interface to provide real-time feedback of one or more components of the system 100 to an operator. For example, the user interface may provide real-time feedback of one or more characteristics of the storage device 102 and the current power consumption of a compressor 110 of the system 100.

The user interface may take the form of a general computer, a handheld device, a siren, one or more visual indicators placed on one or more components of the system 100 (e.g., a light bar disposed on the exterior of the storage device 102), or an equivalent component designed to output information to an operator. The user interface may output alerts when one or more thresholds of one or more characteristics have been met, a component of the system 100 has been automatically actuated or modulated, a component of the system 100 is recommended to be manually actuated or modulated, a malfunction or obstruction in a component of the system 100 is detected, maintenance of a component of the system 100 is required, etc.

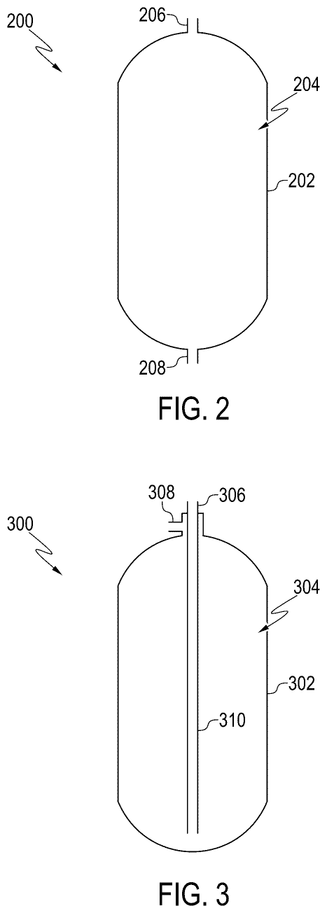

FIG. 2 depicts a schematic diagram of a storage device 102 according to one or more embodiments of the present disclosure. In one or more embodiments, the storage device 102 may be a storage tank 200. In the non-limiting example of FIG. 2, a storage tank 200 includes a main body 202 that is generally hollow defining an interior chamber 204. The main body 202 may be constructed from a strong, rigid material (e.g., steel, carbon fiber, or a combination thereof) suitable to store a compressible fluid at pressures up to 4,000 psig or greater.

In one or more embodiments, the storage tank 200 includes an inlet 206 operable to receive compressible fluid and an outlet 208 operable to deliver compressible fluid. The storage tank 200 is operable to receive and deliver compressible fluid simultaneously. In the non-limiting example of FIG. 2, the inlet 206 is disposed at a first end of the main body 202 and the outlet 208 is disposed at an opposite, second end of the main body 202.

Alternatively, the inlet 306 and the outlet 308 of a storage tank 300 may be disposed at a same end of the main body 302, as depicted in FIG. 3. In addition, the storage tank 300 may further include a conduit 310 operable to extend within the interior chamber 304 from the inlet 306 towards an opposite end of the main body 302. As such, compressible fluid entering the inlet 306 of the storage tank 300 may enter the interior chamber 304 at a predetermined distance from the inlet 306 and the outlet 308. Alternatively, in one or more embodiments, the conduit 310 may instead extend within the interior chamber 304 from the outlet 308 towards an opposite end of the main body 302, such that compressible fluid exiting the storage tank 300 must first enter an end of the conduit 310 set a predetermined distance away from the outlet 308 and the inlet 306. In both examples, the conduit 310 serves to promote a mixing of the compressible fluid entering the storage tank 300 with the compressible fluid already disposed within the interior chamber 304. In addition, the conduit 310 serves to prevent compressible fluid from flowing directly from the inlet 306 to the outlet 308 without first mixing with the compressible fluid already disposed in the interior chamber 304.

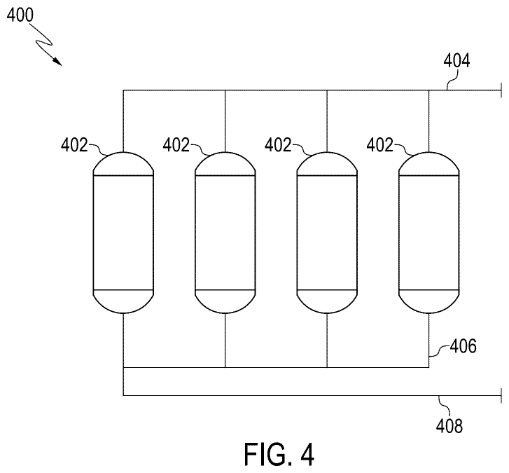

FIG. 4 depicts another embodiment of a storage device 102 according to one or more embodiments of the present disclosure. In the non-limiting example of FIG. 4, the storage device 102 includes a storage tank array 400. The storage tank array 400 includes a plurality of storage tanks 402 fluidly connected in parallel between an inlet manifold 404 and an outlet manifold 406. The storage tanks 402 of the storage tank array 400 may be of any form, including either of the storage tanks 200, 300 depicted in FIGS. 2 and 3.

The inlet manifold 404 of the storage tank array 400 is operable to be in fluid communication with the inlet of each storage tank 402 of the plurality of storage tanks 402 of the storage tank array 400. In addition, the inlet manifold 404 is operable to be in fluid communication with the circulation line 108 of the system 100. As such, the inlet manifold 404 is operable to deliver the second portion of the compressible fluid from the circulation line 108 to the inlet of each storage tank 402 of the plurality of storage tanks 402 simultaneously. Further, the outlet manifold 406 of the storage tank array 400 is operable to be in fluid communication with the outlet of each storage tank 402 of the plurality of storage tanks 402 of the storage tank array 400, as well as one or more flow lines of the plurality of flow lines (e.g., the distribution line 106 and the circulation line 108). Accordingly, the outlet manifold 406 is operable to simultaneously deliver a portion of the compressible fluid from the outlet of each storage tank 402 of the plurality of storage tanks 402 to one or more flow lines of the plurality of flow lines.

In the non-limiting example of FIG. 4, the outlet manifold 406 includes a flow equalization line 408 in the form of a “doubled-back” line. The flow equalization line 408 may be operable to promote equal flow distribution through the outlet of each storage tank 402 of the plurality of storage tanks 402 in fluid communication with the outlet manifold 406. In one or more embodiments, the inlet manifold 404 may instead or additionally include a flow equalization line 408 that is operable to promote equal flow distribution through the inlet of each storage tank 402 of the plurality of storage tanks 402 in fluid communication with the inlet manifold 404. Accordingly, flow equalization lines 408 may be employed to promote approximately equal flow from the inlet manifold 404 into each of the storage tanks 402 and to promote approximately equal flow out of each storage tank 402 into the outlet manifold 406.

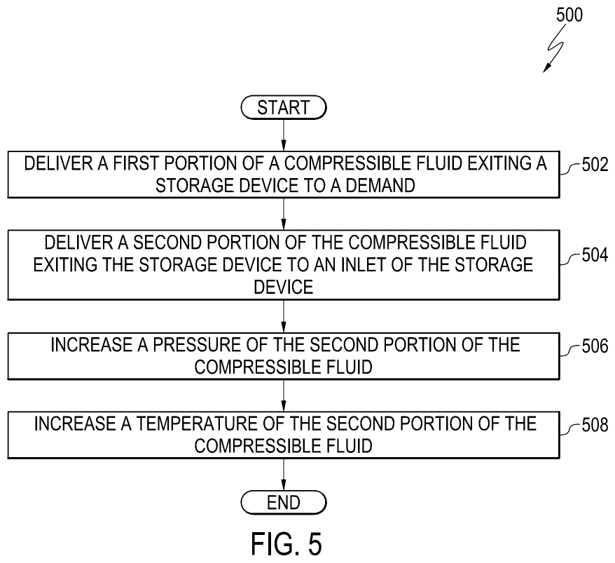

FIG. 5 depicts a logic flow diagram of a method 500 according to one or more embodiments of the present disclosure. Specifically, the method 500 describes an emptying operation of a storage device 102 employing a system 100 according to one or more embodiments of the present disclosure. While the various functions described in FIG. 5 are presented and described sequentially, one of ordinary skill in the art will appreciate that some or all of the steps may be executed in different orders, may be combined or omitted, and some or all of the steps may be executed in parallel. Furthermore, the steps may be performed actively or passively.

Initially, one or more stoppage valves 112 of a system 100 are actuated such that a first portion of the compressible fluid is delivered 502 from an outlet of a storage device 102 to a demand 104 through a distribution line 106. In one or more embodiments, the flow rate of the first portion of the compressible fluid through the distribution line 106 is controlled by one or more flow control valves 114 of the system 100. In one or more embodiments, the temperature of the first portion of the compressible fluid is controlled by a distribution heater 116 thermally coupled to the distribution line 106 as the first portion of the compressible fluid is delivered 502 from the storage device 102 to the demand 104.

Further, one or more stoppage valves 112 of the system 100 are actuated such that a second portion of the compressible fluid is delivered 504 from the outlet of a storage device 102 to an inlet of the storage device 102 through a circulation line 108. As such, the second portion of the compressible fluid is returned to the storage device 102, and the first portion of the compressible fluid is delivered 502 to the demand 104 and removed from the system 100. Thus, the density of the compressible fluid within the storage device 102 declines during the emptying operation.

In one or more embodiments, the one or more stoppage valves 112 operable to permit delivery of the first portion of the compressible fluid and the one or more stoppage valves 112 operable to permit delivery of the second portion of the compressible fluid are actuated simultaneously. In one or more embodiments, the one or more stoppage valves 112 operable to permit delivery of the second portion of the compressible fluid are actuated subsequent to the actuation of the one or more stoppage valves 112 operable to permit delivery of the first portion of the compressible fluid. For example, the one or more stoppage valves 112 operable to permit delivery of the second portion of the compressible fluid may be actuated in response to one or more characteristics of the of the compressible fluid within or exiting the storage device 102 meeting a predetermined threshold. Alternatively, the one or more stoppage valves 112 operable to permit delivery of the second portion of the compressible fluid may be actuated after a predetermined period of time has elapsed since the actuation of the one or more stoppage valves 112 operable to permit delivery of the first portion of the compressible fluid.

Prior to the second portion of the compressible fluid entering the inlet of the storage device 102, the pressure of the second portion of the compressible fluid is increased 506 by a compressor 110 fluidly coupled to the circulation line 108. In addition, the temperature of the second portion of the compressible fluid is increased 508 by a circulation heater 118 thermally coupled to the circulation line 108 prior to the second portion of the compressible fluid entering the inlet of the storage device 102. In one or more embodiments, the flow rate of the second portion of the compressible fluid through the circulation line 108 may be determined by the specifications of the compressor 110. That is, in one or more embodiments, the compressor 110 is operable to maintain the flow rate of second portion of the compressible fluid at or above a minimum flow rate through the compressor 110 (e.g., approximately 2.5 MMscf/d or approximately 2000 ft³/hr) for at least a portion of the emptying operation. Alternatively, or in addition, the flow rate of the second portion of the compressible fluid may be controlled by one or more flow control valves 114 in fluid communication with the circulation line 108.

In one or more embodiments, the first portion of the compressible fluid is continuously delivered 502 to the demand 104 until one or more characteristics of the compressible fluid within or exiting the outlet of the storage device 102 meet a predetermined threshold. Subsequently, one or more stoppage valves 112 of the system 100 are automatically or manually actuated to prevent additional compressible fluid from being delivered to the demand 104. In one or more embodiments, one or more stoppage valves 112 of the system 100 may be actuated to prevent fluid communication between the demand 104 and the distribution line 106 or the outlet of the storage device 102.

In one or more embodiments, the second portion of compressible fluid is continuously delivered 504 to the inlet of the storage device 102 until the flow of the first portion of the compressible fluid is halted. That is, in one or more embodiments, the flow of the first portion of the compressible fluid and the flow of the second portion of compressible fluid are halted simultaneously. As such, in one or more embodiments, one or more stoppage valves 112 of the system 100 may be automatically or manually actuated to prevent compressible fluid from both entering or exiting the storage device 102 in response to one or more characteristics of the compressible fluid within or exiting the outlet of the storage device 102 meeting a predetermined threshold.

Alternatively, in one or more embodiments, the flows of the first compressible fluid and the second compressible fluid may be halted at different times during an emptying operation. In one or more embodiments, the second portion of the compressible fluid is continuously delivered 504 to the inlet of the storage device 102 until one or more characteristics of the compressible fluid within or exiting the outlet of the storage device 102 meet a predetermined threshold. For example, the second portion of the compressible fluid may be continuously delivered 504 to the inlet to the demand 104 until a pressure within the storage device 102 falls below a predetermined pressure. Subsequently, one or more stoppage valves 112 of the system 100 are automatically or manually actuated to prevent additional compressible fluid from entering the inlet of the storage device 102. As such, one or more stoppage valves 112 of the system 100 may be actuated to prevent fluid communication between the inlet of the storage device 102 and the circulation line 108 or the outlet of the storage device 102.

In one or more embodiments, one or more stoppage valves 112 may be actuated in order to fluidly disconnect the storage device 102 from the plurality of flow lines. Further, in one or more embodiments, the storage device 102 may be coupled to a vehicle. A vehicle should be understood as to include any method of transportation for compressible fluid storage equipment known in the art (e.g., a truck, a crane, etc.). As such, a vehicle may transport a disconnected storage device 102 to another location away from the system 100 subsequent to the storage device 102 being disconnected from the plurality of flow lines of the system 100.

Additionally, in one or more embodiments, one or more stoppage valves 112 of the system 100 may be actuated in order to fluidly connect an additional storage device 102 to the plurality of flow lines. An additional storage device 102 may include a pressure greater than a previously disconnected storage device 102 or be a nominally full storage device 102. In one or more embodiments, a vehicle may transport an additional storage device 102 to the system 100 from another location away from the system 100 prior to the additional storage device 102 being connected to the plurality of flow lines.

In one or more embodiments, a disconnected storage device 102 may be transported to a high-pressure source (e.g., a gas filling station) in order to receive additional compressible fluid. As such, subsequent to a disconnected storage device 102 receiving additional compressible fluid and the additional compressible fluid within the disconnected storage device 102 reaching a predetermined pressure, the disconnected storage device 102 becomes an additional storage device 102 and may be returned to and connected to the system 100.

Subsequent to an additional storage device 102 being fluidly connected to the plurality of flow lines by the actuation of one or more stoppage valves 112, the method 500 may restart and an emptying operation of the additional storage device 102 may commence.

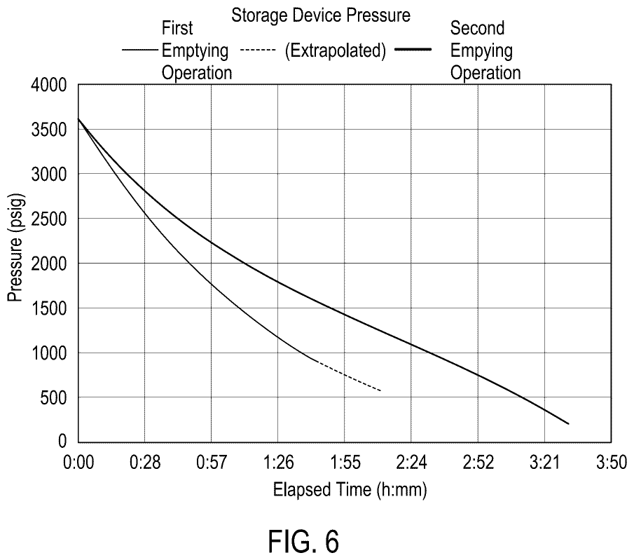

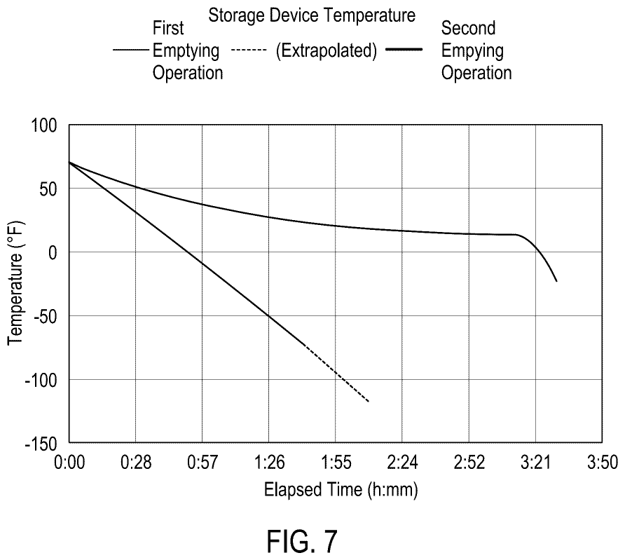

FIGS. 6 and 7 present graphs which compare example conditions of a first emptying operation and a second emptying operation. Specifically, FIGS. 6 and 7 respectively depict graphs of example pressures and temperatures of a compressible fluid (e.g., CNG) within a storage device of the first emptying operation and the second emptying operation. The first emptying operation includes an emptying operation of a base case (e.g., a system including a single flow line extending between and fluidly connecting a storage device and a demand). The second emptying operation employs a system 100 according to one or more embodiments of the present disclosure (e.g., the emptying operation described in relation to FIG. 5).

Initially, the gas within the base case storage device of the first emptying operation and the gas within the storage device 102 of the second emptying operation begin with similar conditions (e.g., the gas within the base case storage device and the gas within the storage device 102 include initial temperatures of approximately 70° F. and initial pressures of approximately 3,600 psig). In addition, the flow rate of the gas delivered to the demand in the first emptying operation and the flow rate of the gas delivered to the demand 104 in the second emptying operation are the same (e.g., approximately 3 MMscf/d). However, the pressures and temperatures observed throughout the first emptying operation are lower than the respective pressures and temperatures observed during the second emptying operation after commencement of the first and second emptying operations (e.g., FIGS. 6 and 7).

During the first emptying operation, gas is solely delivered from an outlet of the base case storage device to a demand. As shown in FIG. 7, the first emptying operation is halted when the temperature within the base case storage device reaches a minimum operating temperature of the base case storage device (e.g., approximately −70°F.). It can be seen from FIG. 6 that the gas within the base case storage device includes a pressure of approximately 900 psig at the time the first emptying operation is halted.

During the second emptying operation, a first portion of gas is delivered from the outlet of the storage device 102 to the demand 104 (e.g., at a flow rate of approximately 3 MMscf/d), and a second portion of gas is delivered from the outlet of the storage device 102 to the inlet of the storage device 102 (e.g., at a flow rate of approximately 2.5 MMscf/d). Accordingly, the storage device 102 of the second emptying operation delivers and receives gas simultaneously. In one or more embodiments, one or more characteristics of the second portion of gas (e.g., temperature, pressure, flow rate, etc.) may be controlled prior to the second portion of gas reentering the storage device 102 such that one or more characteristics of the gas within the storage device 102 remain above a predetermined value. To this end, during the example second emptying operation, the second portion of gas is compressed by a compressor 110 and heated by a circulation heater 118 prior to reentering the storage device 102. In this way, the pressures and temperatures of the gas within the storage device 102 of the second emptying operation remain greater than the respective pressures and temperatures of the gas within the base case storage device of the first emptying operation. Furthermore, because the gas received by the storage device 102 is heated, the temperature within the storage device 102 remains above a minimum operating temperature of the storage device 102 (e.g., approximately −70°F.) throughout the second emptying operation. As a result, gas may be delivered continuously and uninterrupted from the storage device 102 to the demand 104 until the pressure of the gas within the storage device 102 falls below a predetermined pressure threshold (e.g., approximately 250 psig).

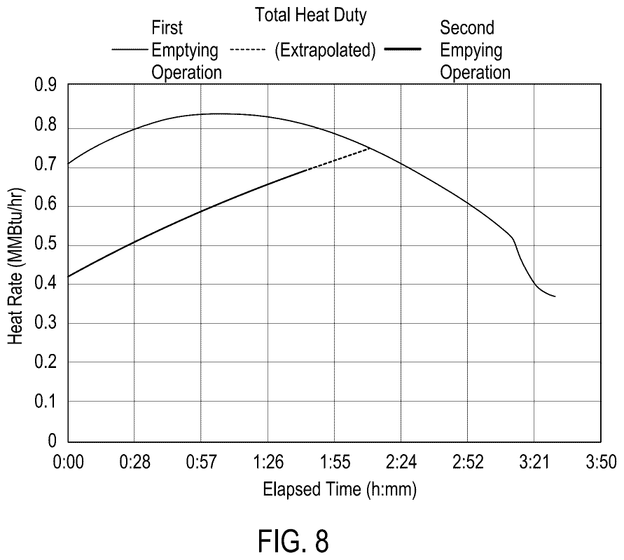

FIG. 8 presents a graph which compares example total heat duties during the first emptying operation and the second emptying operation. The variation in total heat duties between the first emptying operation and the second emptying operation should be readily apparent to those of ordinary skill in the art.

In the first emptying operation, the gas delivered to the demand from the base case storage device is heated to approximately 50° F. at 200 psig by a heating device. As illustrated by FIG. 8, the heat duty associated with the first emptying operation increases throughout the duration of the first emptying operation. This is due to the increase in energy required by the heating device of the first emptying operation to maintain a same output temperature of the gas delivered from the base case storage device to the demand as the temperature within the base case storage device decreases (e.g., FIG. 7).

In the second emptying operation, the first portion of gas (e.g., gas delivered to the demand 104) is similarly heated to approximately 50° F. at 200 psig by a distribution heater 116. In addition, the second portion of gas (e.g., gas delivered to the inlet of the storage device 102) is heated to approximately 150° F. by a circulation heater 118. Accordingly, because the second emptying operation includes both a distribution heater 116 having an output temperature of approximately 50° F. and a circulation heater 118 having an output temperature of approximately 150° F., the total heaty duty of the second emptying operation is initially greater than the total heat duty of the first emptying operation. However, because the gas conditions within the storage device 102 and base case storage device change throughout each emptying operation, the peak total heat duty of the second emptying operation is only modestly greater than the peak total heat duty of the first emptying operation.

FIGS. 6-8 further depict an extrapolation of the first emptying operation. The extrapolation depicts the example conditions (e.g., pressure, temperature, or total heat duty) of the first emptying operation if the first emptying operation was continued until the gas within the base case storage device reached the hydrocarbon dew point (e.g., the temperature at which the hydrocarbon components of the gas begin to condense into liquid). As can be seen by FIG. 6, the second emptying operation allows for greater gas removal from a storage device 102 than the first emptying operation, even if the first emptying operation was continued until the gas within the base case storage device reached the hydrocarbon dew point.

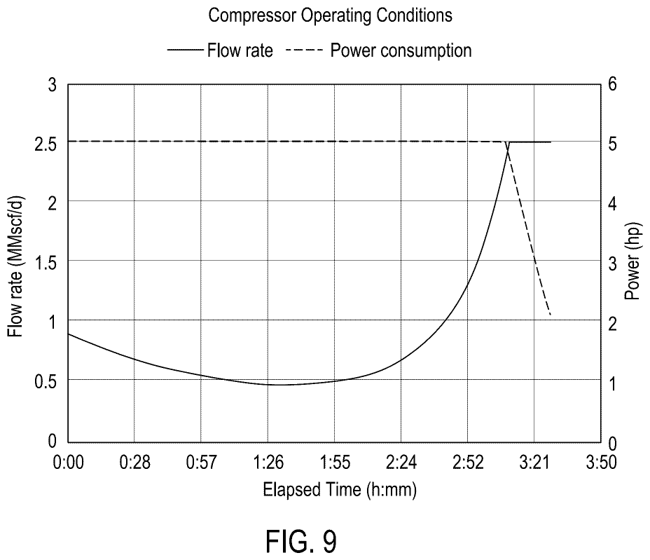

FIG. 9 is a graph depicting example operating conditions of a compressor 110 during the second emptying operation. Specifically, FIG. 9 shows the operating flow rate and power consumption of a compressor 110 employed to compress the second portion of gas during the second emptying operation.

During the second emptying operation, the flow rate through the compressor 110 is maintained at a design flow rate of the compressor 110 (e.g., approximately 2.5 MMscf/d) until the amount of gas within the system 100 diminishes to a point such that the maximum flow rate through the compressor 110 can no longer be maintained. As seen in FIG. 9, the power consumption of the compressor 110 reaches a maximum (e.g., approximately 5 hp) as the flow rate through the compressor 110 falls below the maximum flow rate of the compressor 110. In one or more embodiments, the compressor 110 may be sized according to capital and operational expense requirements.

In the examples of FIGS. 6-9, the duration of the second emptying operation is approximately 3.5 hours. However, this time may be longer or shorter depending on several different variables of the system 100 (e.g., the initial conditions of the gas within the storage device 102, the flow rates of the first portion of gas and the second portion of gas, etc.). In one or more embodiments, the second emptying operation concludes subsequent to one or more characteristics of the gas within or exiting the storage device 102 meeting a predetermined threshold. For example, the second emptying operation of the system 100 concludes subsequent to the gas within the storage device 102 falling below a pressure of approximately 250 psig.

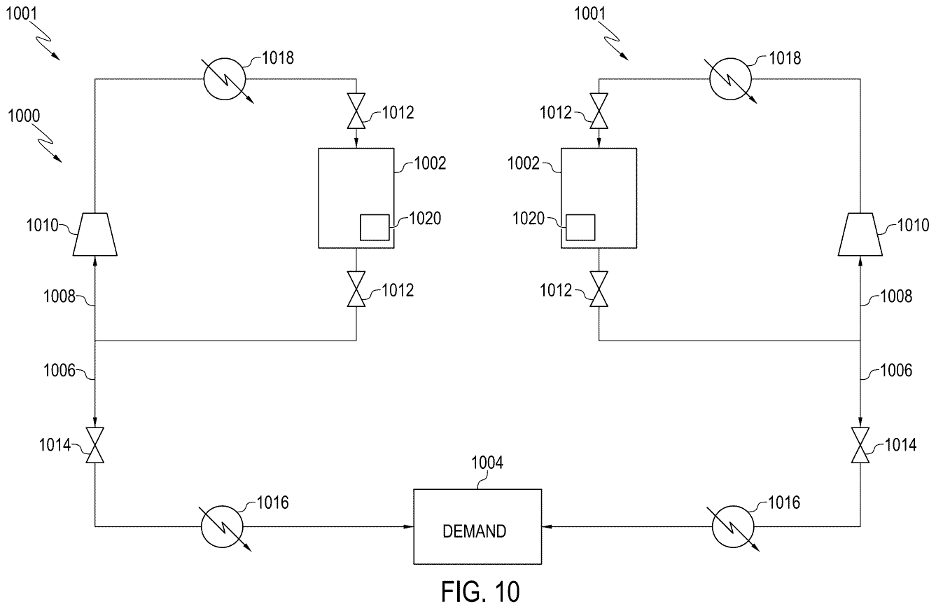

FIG. 10 depicts a schematic diagram of an assembly 1000 according to one or more embodiments of the present disclosure. Components shown or described in FIGS. 1-5 have not been redescribed for purposes of readability and have the same description and purpose as outlined above. In one or more embodiments, the assembly 1000 may include a plurality of systems 1001 as described above in FIGS. 1-5. In the non-limiting example of FIG. 10, the assembly 1000 includes a first system 1001 and a second system 1001. However, the assembly 1000 may include a greater number of systems 1001.

Each system 1001 includes a storage device 1002, a plurality of flow lines (e.g., a distribution line 1006 and a circulation line 1008), one or more stoppage valves 1012, and one or more flow control valves 1014. In one or more embodiments, each system 1001 may further include one or more components fluidly or thermally coupled to the distribution line 1006 of the system 1001 (e.g., a distribution heater 1016). In one or more embodiments, one or more components may be in fluid or thermal communication with the distribution lines 1006 of multiple systems 1001. For example, a first distribution heater 1016 may be utilized to control the temperature of the compressible fluid within each distribution line 1006 of a first set of systems 1001 and an additional distribution heater 1016 may be utilized to control the temperature of the compressible fluid within each distribution line 1006 of an additional set of systems 1001.

In one or more embodiments, each system 1001 may further include one or more components fluidly or thermally coupled to the circulation line 1008 of the system 1001 (e.g., a circulation heater 1018, a compressor 1010, etc.). In one or more embodiments, one or more components may be in fluid or thermal communication with the circulation lines 1008 of multiple systems 1001. For example, a first circulation heater 1018 may be utilized to control the temperature of the compressible fluid within each circulation line 1008 of a first set of systems 1001 and an additional circulation heater 1018 may be utilized to control the temperature of the compressible fluid within each circulation line 1008 of an additional set of systems 1001.

As shown in FIG. 10, a distribution line 1006 of two or more systems 1001 may be fluidly coupled to a same demand 1004. In one or more embodiments, the distribution lines 1006 of two or more systems 1001 may be in fluid communication. For example, the distribution lines 1006 of two or more systems 1001 may fluidly connect prior reaching a demand 1004 such that compressible fluid from two or more systems 1001 is delivered to the demand 1004 through a single flow line. In one or more embodiments, one or more flow control valves 1014 may be fluidly coupled to this single flow line to control the rate at which compressible fluid is delivered to the demand 1004 from two or more systems 1001. Further, in one or more embodiments, one or more distribution heaters 1016 may be thermally coupled to this single flow line to control the temperature at which compressible fluid is delivered to the demand 1004 from two or more systems 1001.

In one or more embodiments, each system 1001 may further include a control circuit in electronic communication with one or more components of the system 1001 (e.g., one or more stoppage valves 1012, one or more flow control valves 1014, one or more compressors 1010, a plurality of heaters, one or more sensors 1020, etc.). Alternatively, in one or more embodiments, the assembly 1000 may include one or more control circuits in electronic communication with components of two or more system 1001 of the assembly 1000. In this way, a single control circuit of an assembly 1000 may be operable to control two or more systems 1001 of the assembly 1000 independently. For example, a single control circuit may only actuate one or more stoppage valves 1012 of a first system 1001 based on signals received from one or more sensors 1020 of the first system 1001 and may only actuate one or more stoppage valves 1012 of a second system 1001 based on signals received from one or more sensors 1020 of the second system 1001.

While various embodiments of systems 100, 1001 and methods 500 were provided in the foregoing description, those skilled in the art may make modifications and alterations to these aspects without departing from the scope of the claimed subject matter. For example, it is to be understood that this disclosure contemplates that, to the extent possible, one or more features of any aspect can be combined with one or more features of any other aspect. As another non-limiting specific example, because natural gas is often odorless, as those of ordinary skill in the art will appreciate it is customary to add an odorant, such as ethyl mercaptan, so that a gas leak can be detected anywhere the gas is being processed or consumed. Therefore, such an odorant can be added to any of the gas products produced in accordance with the present disclosure. Accordingly, the foregoing description is intended to be illustrative rather than restrictive. The present disclosure described hereinabove is defined by the appended claims, and all changes to the aspects described in the present disclosure that fall within the meaning and the range of equivalency of the claims are to be embraced within their scope.

The foregoing detailed description has set forth various forms of the systems 100, 1001 and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted being prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A system comprising:
a storage device to receive and deliver a compressible fluid simultaneously;
a distribution line to fluidly couple an outlet of the storage device to a demand to deliver a first portion of the compressible fluid exiting the storage device to the demand;
a circulation line to fluidly couple the outlet of the storage device to an inlet of the storage device to deliver a second portion of the compressible fluid exiting the storage device to the inlet of the storage device;
a compressor in fluid communication with the circulation line to increase a pressure of the second portion of the compressible fluid; and
a circulation heater in thermal communication with the circulation line to increase a temperature of the second portion of the compressible fluid.

2. The system of claim 1, comprising a distribution heater in thermal communication with the distribution line to increase a temperature of the first portion of the compressible fluid.

3. The system of claim 1, comprising a flow control valve in fluid communication with the distribution line to control a flow rate of the first portion of the compressible fluid.

4. The system of claim 1, comprising one or more sensors to measure one or more characteristics of the compressible fluid within or exiting the storage device.

5. The system of claim 4, comprising one or more stoppage valves to control a flow of the compressible fluid exiting the storage device, wherein the one or more stoppage valves are operable to actuate based on the one or more characteristics of the compressible fluid within or exiting the storage device meeting a threshold.

6. The system of claim 4, wherein the one or more characteristics of the compressible fluid within or exiting the storage device comprise one or more of:
a temperature of the compressible fluid; or
a pressure of the compressible fluid.

7. The system of claim 1, wherein the storage device is a storage tank array comprising a plurality of storage tanks fluidly coupled in parallel between:
an inlet manifold to deliver the second portion of the compressible fluid from the circulation line to an inlet of each storage tank of the plurality of storage tanks; and
an outlet manifold to deliver a portion of the compressible fluid from an outlet of each storage tank of the plurality of storage tanks to the distribution line and the circulation line.

8. The system of claim 7, wherein the inlet of each storage tank is disposed at a first end of the storage tank and the outlet of each storage tank is disposed at a second end of the storage tank.

9. The system of claim 7, wherein the inlet and the outlet of each storage tank are disposed at a first end of the storage tank, and each storage tank comprises a conduit extending, within an interior of the storage tank, from the inlet or the outlet towards a second end of the storage tank.

10. A method comprising:
delivering a first portion of a compressible fluid exiting a storage device to a demand;
delivering a second portion of the compressible fluid exiting the storage device to an inlet of the storage device;
increasing a pressure of the second portion of the compressible fluid; and
increasing a temperature of the second portion of the compressible fluid.

11. The method of claim 10, further comprising increasing a temperature of the first portion of the compressible fluid.

12. The method of claim 10, further comprising controlling a flow rate of the first portion of the compressible fluid.

13. The method of claim 10, further comprising measuring one or more characteristics of the compressible fluid within or exiting the storage device.

14. The method of claim 13, further comprising controlling a flow of the compressible fluid exiting the storage device based at least in part on the one or more characteristics of the compressible fluid within or exiting the storage device meeting a threshold.

15. The method of claim 14, further comprising:
fluidly disconnecting the storage device from the demand; and
fluidly connecting an additional storage device to the demand.

16. An assembly comprising:
a demand; and
a plurality of systems, each system comprising:
a storage device to receive and deliver a compressible fluid simultaneously;
a distribution line to fluidly couple an outlet of the storage device and the demand to deliver a first portion of the compressible fluid exiting the storage device to the demand;
a circulation line to fluidly couple the outlet of the storage device and an inlet of the storage device to deliver a second portion of the compressible fluid exiting the storage device to the inlet of the storage device;
a compressor in fluid communication with the circulation line to increase a pressure of the second portion of the compressible fluid; and
a circulation heater in thermal communication with the circulation line to increase a temperature of the second portion of the compressible fluid.

17. The assembly of claim 16, wherein each system comprises a distribution heater in thermal communication with the distribution line to increase a temperature of the first portion of the compressible fluid.

18. The assembly of claim 16, wherein each system comprises a flow control valve in fluid communication with the distribution line to control a flow rate of the first portion of the compressible fluid.

19. The assembly of claim 16, wherein each system comprises one or more sensors to measure one or more characteristics of the compressible fluid within or exiting the storage device.

20. The assembly of claim 19, wherein each system comprises one or more stoppage valves to control a flow of the compressible fluid exiting the storage device, wherein the one or more stoppage valves are operable to actuate based on the one or more characteristics of the compressible fluid within or exiting the storage device meeting a threshold.
